(19) United States
(12) Patent Application Publication
(10) Pub. No.: US 2010/0049864 A1
(43) Pub. Date: Feb. 25, 2010

(54) MULTIMEDIA BROADCAST SYSTEM AND METHOD

(75) Inventors: Meng-Ting Lu, Taipei (TW); Jui-Chieh Wu, Taipei (TW); Polly Huang, Taipei (TW); Jeyhsin Yao, Taipei (TW); Homer H. Chen, Taipei (TW)

Correspondence Address: EDWARDS ANGELL PALMER & DODGE LLP, P.O. BOX 55874, BOSTON, MA, 02205, US

(73) Assignee: NATIONAL TAIWAN UNIVERSITY, Taipei (TW)

(21) Appl. No.: 12/359,332

(22) Filed: Jan. 25, 2009

(30) Foreign Application Priority Data
Aug. 25, 2008 (TW) 97132344

(51) Int. Cl. G06F 15/16

(52) U.S. Cl. 709/231

(57) ABSTRACT

A multimedia broadcast system and method supporting peer-to-peer (P2P) coordinated code conversion are provided. The method includes forming, by a data source device, one or more data segments from multimedia data, and then scattering the data segments to a P2P network formed by the viewers; wherein an individual P2P device is connected with one or more P2P devices via a network system to form a partner group, and then acquires code conversion degrees of each data segment to serve as a basis for strategically adjusting the coordinated code conversion of said multimedia data. The coordinated code conversion mechanism is supported by common P2P multimedia broadcast systems, and is capable of rapidly converting the multimedia data in one format into multimedia data in other different media formats, thereby enabling real-time broadcasting of data in different formats to clients using P2P networks of various specifications.

### BACKGROUND OF THE INVENTION

1. Field of the Invention

This invention relates to multimedia broadcast systems and methods of the same and, more particularly, to a multimedia broadcast system and method supporting P2P coordinated code conversion.

2. Description of Related Art

Owing to ever-developing computer networks and increasing use of network application by people at work and at home, traffic of data transmission is becoming heavier than ever before. However, the increase of bandwidth available on existing networks always lags behind that of data transmission traffic. The shortage of bandwidth poses a bottleneck for the betterment of our daily life which is increasingly dependent on network-based data transmission. It is thanks to the recent emergence of peer-to-peer (or P2P) computer network technology that revolutionary change has come to network architecture and expansion, allowing the bandwidth bottleneck to be eliminated with existing, rather than additional, resources. The impact of the P2P networking technology on our daily life is instant and widespread. Immediate beneficiaries of the P2P networking technology abound. Network multimedia providers and users are some of them for sure.

P2P IPTV is a newly developed multimedia data broadcasting technology built within a P2P system to enable a network multimedia provider to broadcast multimedia video data, such as live TV programs or recorded video extracts to various end-user devices, e.g. mobile phones, personal digital assistants (PDAs), personal computers (notebook computers or desk top computers), etc., and MPEG-4 and WMV are mostly used data formats in the present P2P IPTV broadcasting systems.

However, a practical application problem of the present IPTV broadcast technology is that there are various screen display specifications or settings among different end-user devices; for instance, smart mobile phones and personal digital assistants may have display screens of VGA format (640×480) or QVGA format (320×240). Therefore, before broadcasting multimedia video data to end-user devices, the network multimedia provider has to perform a code converting task on the multimedia video data; for instance, converting the MPEG-4 or WMV format into MDC (multiple description coding) or LVC (layered video coding) format. Then, multimedia video data of various display formats are created and provided for end-user devices having different screen display specification, so as to enable end-user devices having low resolution monitors to download video streaming of low resolution QVGA format, and enable end-user devices having high resolution monitors to download video streams of high resolution VGA format.

However, in practice, each data segment has to be converted into many kinds of display format in the process of multimedia data code conversion, and in consequence the process takes a lot of time and uses considerable system resources, seriously taking up computation capability of multimedia data providing device. Consequently, when the network is in a poor quality condition, a live program of multimedia video data has lower continuity index, namely, discontinuity keeps happening in the process of broadcasting.

In view of the above, it is a highly urgent issue in the field of multimedia broadcast system to provide a multimedia broadcast system of high speed and high efficiency and a method of the same so as to overcome drawbacks of the prior art.

### SUMMARY OF THE INVENTION

In view of the aforesaid drawbacks of the prior art, it is a primary objective of the present invention to provide a multimedia broadcast system supporting P2P coordinated code conversion for use in a network system. The multimedia broadcast system includes: a data source device for providing multimedia data; and a plurality of P2P devices for receiving the multimedia data via the network system and then performing coordinated code conversion on the multimedia data, wherein each of the P2P devices is connected to another P2P device or other P2P devices via the network system to form a partner group.

In a preferred embodiment, each of the P2P devices further includes: a computation capability evaluation module for evaluating computation capability of the P2P device itself and then generating a device message based on evaluation outcome; a message exchange module for delivering the device message to other P2P devices of the same partner group, and receiving response messages sent back from other P2P devices of the same partner group; a work scheduling module for deciding whether to request a specific peer device to download the multimedia data so as to perform code conversion and/or broadcasting based on the received response message and/or broadcasting situation of the P2P device itself; and a code conversion module for downloading the multimedia data and then performing code conversion thereon based on decision made by the work scheduling module.

It is a further objective of the present invention to provide a multimedia broadcast method supporting P2P coordinated code conversion for use in a multimedia broadcast system including a data source device and a plurality of P2P devices. The multimedia broadcast method includes the steps: (1) the data source device forms one or more data segments from multimedia data; (2) each of the P2P devices connects with one or more P2P devices via the network system to form a partner group, and the P2P device is to acquire the data segments from the data source device; and (3) the P2P device of the partner group acquires schedule and code conversion data from other P2P devices, and then executes coordinated code conversion and downloading on the multimedia data.

In a preferred embodiment, said step (3) further includes: (3-1) a consuming peer device evaluates computation capability thereof, and then generates a device message based on evaluation outcome; (3-2) the consuming peer device delivers the device message to a providing peer of the same partner group; (3-3) the providing peer answers the consuming peer device with a response message; (3-4) the consuming peer device performs work scheduling based on the response message; (3-5) the consuming peer device requests the providing peer device to deliver a specific multimedia data segment based on the outcome of work scheduling; and (3-6) the consuming peer device performs code conversion or broadcasting on the multimedia data segment received.

Compared with the prior art, a multimedia broadcast system and method supporting P2P coordinated code conversion according to the present invention overcome drawbacks of conventional multimedia broadcast systems. The multimedia broadcast system and method supporting P2P coordinated code conversion according to the present invention perform code conversion on multimedia data by adopting P2P distributed and coordinated code conversion. Code conversion tasks of the multimedia data segments are distributed based on computation capability of each end-user device of the P2P system; with coordination with other P2P devices, a specific data format is able to be converted to another video format at a higher speed, thereby enabling multimedia video data to be broadcasted to end-user devices of various display formats. As a testing result, the present invention provides live TV programs with continuity index up to 98%, enabling the live TV programs to be run as instant broadcasting to each end-user device, thereby overcoming disadvantages of time consuming and low efficiency as shown in the prior data code conversion.

### BRIEF DESCRIPTION OF DRAWINGS

The present invention can be more fully understood by reading the following detailed description of the preferred embodiments, with reference made to the accompanying drawings, wherein:

FIG. 1 is an architectural diagram of a multimedia broadcast system supporting P2P coordinated code conversion according to the present invention;

FIG. 2 is an architectural diagram of a preferred embodiment of a multimedia broadcast system supporting P2P coordinated code conversion according to the present invention;

FIG. 3 is an architectural diagram of a P2P device for use in the multimedia broadcast system supporting P2P coordinated code conversion according to the present invention;

FIGS. 4a and 4b are schematic views illustrating message exchanges among a plurality of P2P devices for use in the multimedia broadcast system supporting P2P coordinated code conversion according to the present invention;

FIG. 5 is a schematic view illustrating transmission of messages and data between two P2P devices for use in the multimedia broadcast system supporting P2P coordinated code conversion according to the present invention;

FIG. 6 is an architectural diagram of another preferred embodiment of the multimedia broadcast system supporting P2P coordinated code conversion according to the present invention;

FIG. 7 is a flowchart of a multimedia broadcast method supporting P2P coordinated code conversion according to the present invention; and

FIG. 8 is a flowchart illustrating broadcasting and coordinated code conversion taking place between P2P devices for use in the multimedia broadcast method supporting P2P coordinated code conversion according to the present invention.

### DETAILED DESCRIPTION OF PREFERRED EMBODIMENTS

The following illustrative embodiments are provided to illustrate the disclosure of the present invention; those in the art can apparently understand these and other advantages and effects after reading the disclosure of this specification. The present invention can also be performed or applied by other different embodiments. The details of the specification may be on the basis of different points and applications, and numerous modifications and variations can be devised without departing from the spirit of the present invention.

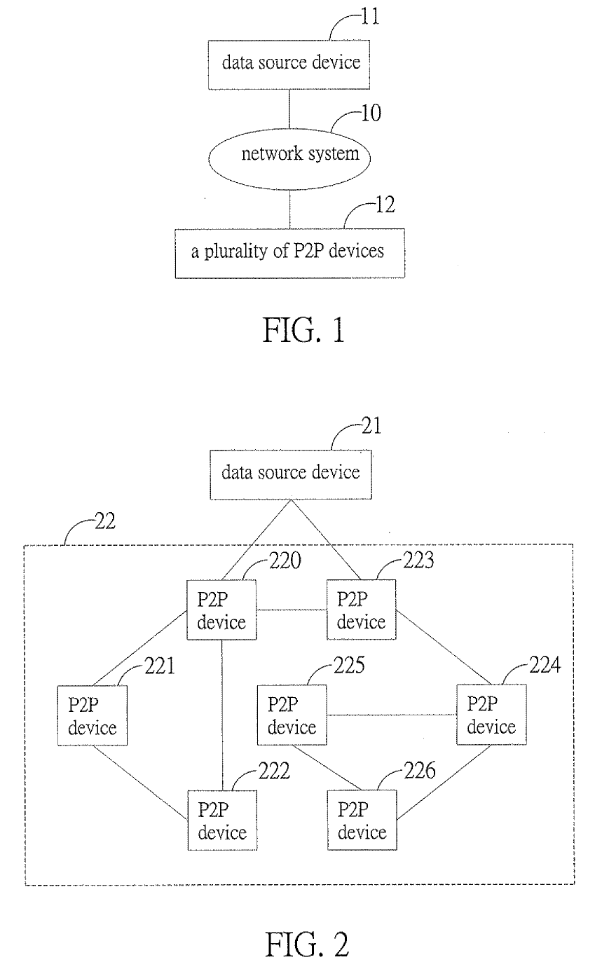

FIG. 1 is an architectural diagram of a multimedia broadcast system supporting P2P coordinated code conversion according to the present invention. As shown in the drawing, a multimedia broadcast system supporting P2P coordinated code conversion according to the present invention comprises a network system 10, a data source device 11, and a plurality of P2P devices 12.

The network system 10 is the medium for data transmission, means of connection thereof can be wired or wireless. The wired network can be Ethernet, Intranet, LAN, WAN, or VPN, and the wireless network can be remote communication technologies, such as WLAN, GSM, GPRS, WiMax, etc.

The data source device 11 and the P2P devices 12 are electronic equipments capable of accessing and processing data, such as desktop computers, notebook computers, personal digital assistants, and/or mobile phones. Any equipment with network connection capability can be used as the data source device 11 and the P2P devices 12. In this regard, the functional difference between the data source device 11 and the P2P devices 12 is that, while the data source device 11 is a multimedia data provider, a P2P device is a multimedia data receiver capable of performing format code conversion or live broadcasting on the received multimedia data.

In practice, the data source device 11 forms a plurality of data segments from multimedia data, and then the data source device 11 delivers the multimedia data in the form of the data segments to the P2P device 12 connected to the data source device 11; subsequently, the P2P device 12 connects another P2P device or a plurality of other P2P devices 12 via the network system 10 to form a partner group; at last, the P2P device 12 of the partner group executes coordinated code conversion and broadcasting on the multimedia data.

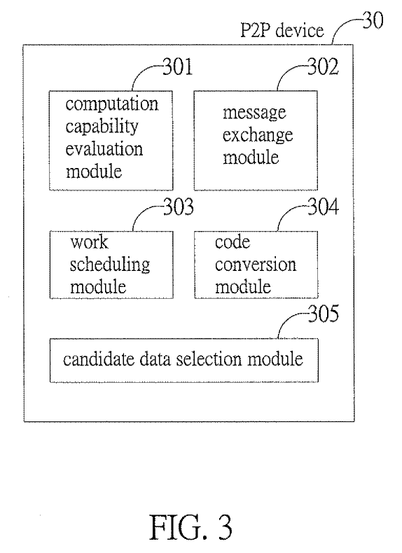

FIG. 2 is an architectural diagram of a preferred embodiment of a multimedia broadcast system supporting P2P coordinated code conversion according to the present invention. As shown in the drawing, data source device 21 is connected to a P2P system 22 via a network. In the present embodiment, the P2P system 22 comprises a plurality of P2P devices 220 through 226, wherein individual P2P device is connected with another or a plurality of other P2P devices via network to form a partner group. For instance, taking P2P device 220 as a core, the P2P device 220 is respectively connected with other P2P devices 221, 222, and 223 via the network, therefore partner group of the P2P device 220 also includes P2P devices 221, 222, and 223. In another example, taking P2P device 221 as a center, the P2P device 221 is respectively connected with P2P devices 220 and 222 via the network, therefore partner group of the P2P device 221 also includes P2P devices 220 and 222. In view of the above, partner group of each P2P device is different from others, and according to the present invention, an individual P2P device can perform message exchange and data delivery only with/to P2P devices of partner group thereof.

Referring to FIG. 3, which is an architectural diagram of a P2P device for use in the multimedia broadcast system supporting P2P coordinated code conversion according to the present invention, a P2P device 30 comprises a computation capability evaluation module 301, a message exchange module 302, a work scheduling module 303, and a code conversion module 304.

The computation capability evaluation module 301 is configured for evaluating computation capability of P2P device, and then generating a device message based on evaluation outcome; evaluation criteria of the computation capability of the P2P device 30 many include available CPU resource, CPU performance, data transmission bandwidth, and/or quantity of data that the P2P device is able to process.

In a preferred embodiment, the quantity of data that the P2P device is able to process in a swarming cycle equals the quotient obtained by dividing duration of the swarming cycle by average code conversion time of an individual datum. Taking code conversion from MPEG-4 format to MDC-STHI format as an example, t_{f} is average code conversion time of fill-size format, t_{q} is average code conversion time of quarter-size format, tₛ is time of a swarming cycle, and Cₛ is quantity of data that a P2P device is able to process in the swarming cycle. Therefore, following equation can be used to evaluate computation capability of the P2P device:

Cₛ=tₛ/(t_{f}+t_{q})

The quantity of data that the P2P device is able to process is calculated as a basis to determine the computation capability of the P2P device.

The message exchange module 302 is configured to deliver the device message to other P2P devices of the same partner group, and also receiving a response message sent back from the other P2P devices of the same partner group. The message exchange module 302 also has partner relation management function, which enabling all P2P devices receiving the same multimedia data to form a P2P system via a gossip message.

In a preferred embodiment, the device message includes a computation capability message, a message of number of requesting peer devices, and/or a data transmission bandwidth message. The response message includes a buffer map of multimedia data having one or more data segments. The buffer map includes a message of code conversion status, a message of code-convertible data, and/or a message of code-converted data.

The work scheduling module 303 is configured to decide whether to request a specific P2P device to download multimedia data and further process code conversion and/or broadcasting based on a response message received and/or broadcasting situation of the P2P device 30.

In a preferred embodiment, the work scheduling module 303 divides an un-decoded data segment shown in the response message into an urgent data segment and a non-urgent data segment before broadcasting ends. In order to avoid interruption of broadcast continuity, and the P2P device is to download the urgent data segment first.

In another preferred embodiment, the work scheduling module 303 calculates a downloading fraction for each data segment, and then decide whether to download the non-urgent data segments based on weight of the downloading fraction.

It is based on decision of the work scheduling module 303 that the code conversion module 304 downloads the multimedia data and then performs code conversion thereon; wherein the multimedia data can be data in formats of MPEG-1, MPEG-2, MPEG-4, H.261, H.263, H.264, WMV, and/or YUV.

In a preferred embodiment, said P2P device further includes a candidate data selection module 305 for deciding whether to show specific multimedia data in a response message while receiving a device message.

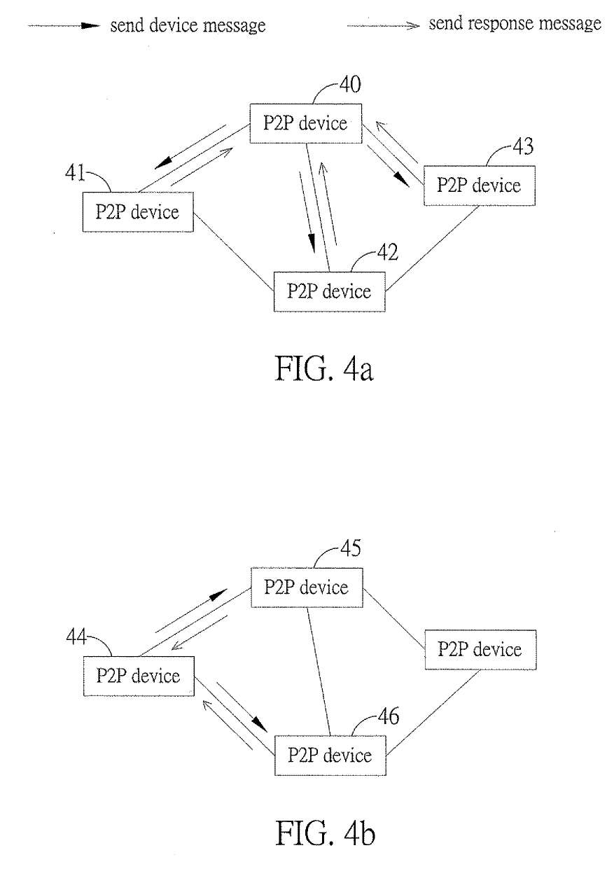

FIGS. 4a and 4b are schematic views illustrating message exchanges among a plurality of P2P devices for use in the multimedia broadcast system supporting P2P coordinated code conversion according to the present invention.

First, look at a P2P device 40 of FIG. 4a; in a swarming cycle, the P2P device 40 is to deliver a device message to P2P devices 41 through 43 of partner group thereof. After receiving the device message, the P2P devices 41 through 43 comprehend present computation capability of the P2P device 40; therefore, the P2P devices 41 through 43 decide whether to show multimedia data segments in the response message. For instance, where the P2P device 40 demonstrates deteriorating capability of CPU processing and therefore is unfit to take on a code conversion task, the P2P devices 41 through 43 hide multimedia data segments requiring code conversion; therefore, after receiving three response messages from the P2P devices 41 through 43, the P2P device 40 finds code-converted data segments in the response messages; for those data segments hardly finished in time for broadcasting, the P2P devices 41 through 43 deliver the unfinished data segments to the P2P device 40, and the P2P device 40 decides whether to pick up and broadcast code-unconverted data.

Next, look at a P2P device 44 of FIG. 4b, similar to the above description, in a swarming cycle, the P2P device 44 delivers the device message to P2P devices 45 and 46 of partner group thereof, and also receives the response messages sent back from the P2P devices 45 and 46. As shown in FIGS. 4a and 4b, each P2P device of a P2P system exchanges messages with other P2P devices of partner group thereof; thereby judging how to perform coordinated code conversion among P2P devices.

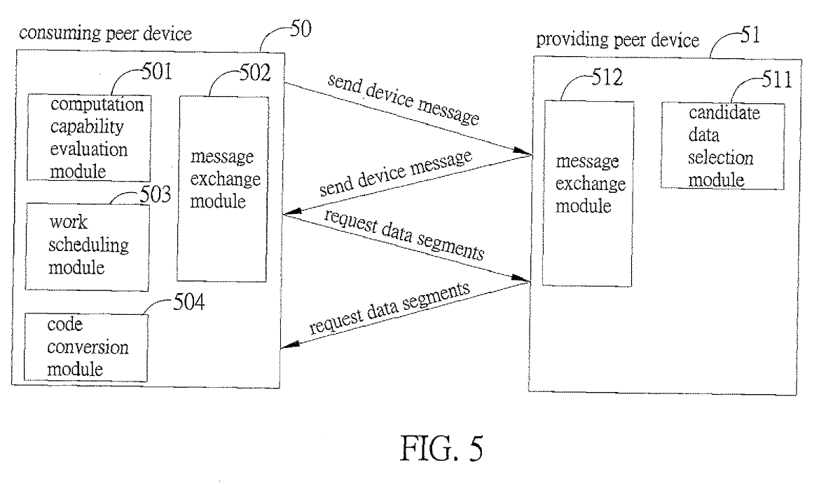

FIG. 5 is a schematic view illustrating transmission of messages and data between two P2P devices for use in the multimedia broadcast system supporting P2P coordinated code conversion according to the present invention. As shown in the drawing, a P2P device that requests multimedia data for performed code conversion or broadcasting may be defined as a consuming peer device 50, and a P2P device that provides the multimedia data may be defined as a providing peer device 51. Since architecture of P2P device has been illustrated in FIG. 3, FIG. 5 illustrates only essential modules for executing message and data transmission.

In a practical application, a computation capability evaluation module 501 evaluates computation capability of the consuming peer device 50, and a device message shown with evaluation outcome is then transmitted to the providing peer device 51 via a message exchange module 502. After receiving the device message, via a candidate data selection module 511, the providing peer device 51 decides, e.g. computation capability of the consuming peer device 50 or code conversion status of the providing peer device 51, whether to include descriptions of multimedia data in a response message and send the response message to the consuming peer device 50 via a message exchange module 512. At this moment, a work scheduling module 503 decides which multimedia data segments to download and which code conversion works to receive based on the response message and status of the work scheduling module 503. At last, the consuming peer device 50 maces a request to the providing peer device 51 for downloading a specific data segment, and then performs code conversion or broadcasting after receiving the specific data segment. It is based on decision of the work scheduling module 503 that the code conversion module 504 downloads the multimedia data and then performs code conversion thereon.

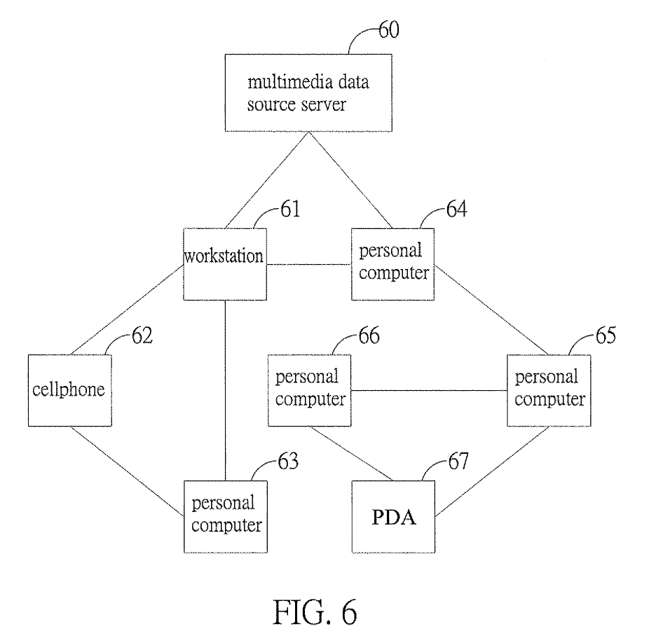

FIG. 6 is an architectural diagram of another preferred embodiment of the multimedia broadcast system supporting P2P coordinated code conversion according to the present invention. As shown in the drawing, a multimedia data source server 60 is a provider of multimedia data, and devices 61 through 67 are receivers of the multimedia data, all together, a P2P system is formed. For instance, video data A in WMV format can be downloaded from the multimedia data source server 60, and all devices 61 through 67 have demand for downloading video data A; however, only workstation 61 and personal computers 63 through 66 are able to broadcast data in WMV format directly, cellphone 62 and PDA 67 can only receive data in smaller display format, and in consequence there is a need to convert data in WMV format to data in MDC format. According to the present invention, the task of converting video data A from WMV format to MDC format is shared by devices 61 through 67 of the P2P system. Moreover, according to the present invention, in a situation even though there is no data request by the PDA 67 or the cellphone 62, all of the workstation 61 and other personal computers 63 through 67 convert data in WMV format into data in MDC format.

First, the multimedia data source server 60 divides the video data A into a plurality of data segments; next, delivering these data segments to the workstation 61 and the personal computer 64. The workstation 61 and the personal computer 64 have to execute code conversion task in addition to broadcasting the data segment directly; therefore, the workstation 61 and its partners, namely the cellphone 62, personal computers 63 and 64, perform message exchanges and allot code conversion tasks based on mechanism described above. Likewise, the personal computer 64 and its partner, namely workstation 61 and personal computer 65 perform message exchange and allot code conversion tasks, and so on. Since code conversion tasks are shared in P2P system, the cellphone 62 and PDA 67 are able to receive video data A in MDC format at a higher speed.

In a preferred embodiment, if a specific device has weak computation capability or is poorly equipped, the device is not to execute computation capability evaluation or code conversion work scheduling in order to avoid affecting performance thereof. For instance, computation capability of the cellphone 62 of FIG. 6 is obviously not as well as computation capability of personal computer or workstation, and in order to avoid affecting performance of the cellphone 62, the cellphone 62 is not to execute functions of computation capability evaluation and code conversion work scheduling. In other words, the cellphone 62 receives code-converted data only but does not perform code conversion task.

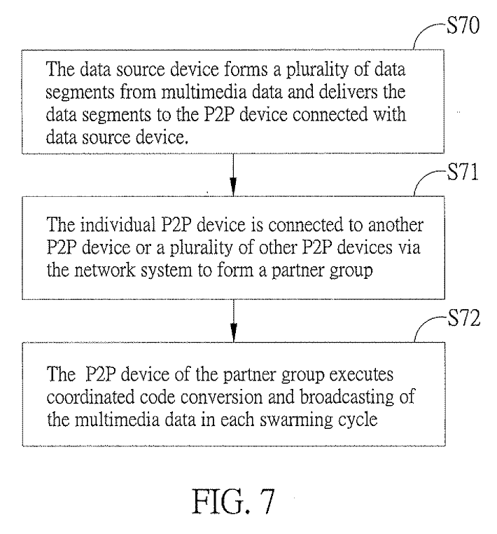

FIG. 7 is a flowchart of a multimedia broadcast method supporting P2P coordinated code conversion according to the present invention. The multimedia broadcast method supporting P2P coordinated code conversion according to the present invention is applied in a multimedia broadcast system which comprises a data source device and a plurality of P2P devices. The multimedia broadcast method of the present invention is described as follows.

In step S70, upon receipt of a request from a P2P device, for delivery of multimedia data, a data source device forms one or more data segments from the multimedia data, and then delivers the data segments to the P2P device connected therewith.

In step S71, an individual P2P device connects with another P2P device or a plurality of other P2P devices to form a partner group via the network system. The partner group is able to perform subsequent coordinated code conversion tasks.

In step S72, the P2P devices of the partner group perform coordinated code conversion and broadcasting on the multimedia data in each swarming cycle.

In a preferred embodiment, the step S70 further comprises: (1) connecting each of P2P devices to the data source device to individually deliver a computation capability message to the data source device; (2) calculating, by the data source device, data distribution fractions based on the computation capability message received; and (3) delivering, by the data source device, different data segments to the P2P devices connected therewith based on weight of data distribution fractions. Since the P2P devices connected with the data source device transmit related information thereof to the data source device, upon receiving a request, the data source device allocates the quantity of data to be downloaded based on system situation of each of the P2P devices, such as size of bandwidth or computation capability.

In another preferred embodiment, the multimedia data are in formats of MPEG-1, MPEG-2, MPEG-4, H.261, H.263, H.264, WMV, YUV, and/or MDC.

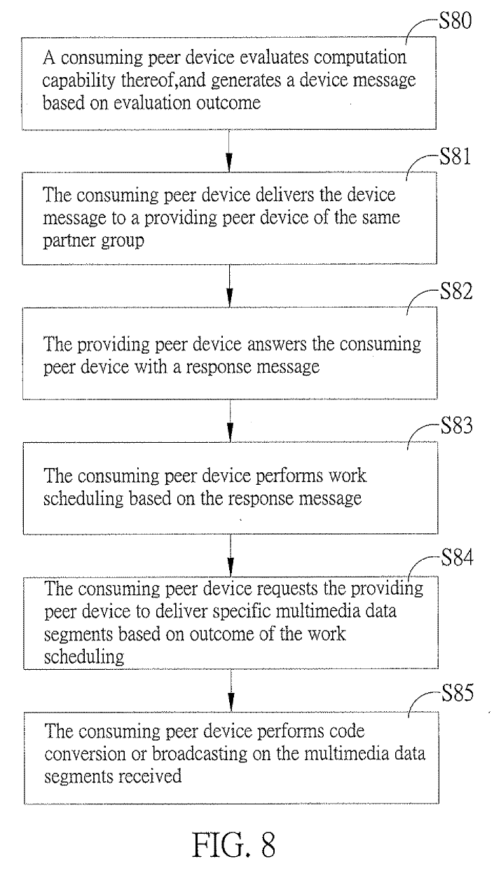

FIG. 8 is a flowchart illustrating broadcasting and coordinated code conversion taking place between P2P devices for use in the multimedia broadcast method supporting P2P coordinated code conversion according to the present invention. This flowchart illustrates an embodiment of step S72 of FIG. 7, and the following descriptions are given also with reference to FIG. 5.

In step S80, the consuming peer device evaluates computation capability thereof, and then generate a device message based on evaluation outcome. The computation capability includes available CPU resource, CPU performance, data transmission bandwidth, and/or quantity of data that the P2P device is able to process in a swarming cycle.

In a preferred embodiment, the quantity of data that the P2P device is able to process in a swarming cycle equals the quotient obtained by dividing the duration of the swarming cycle by average code conversion time of an individual datum.

In another preferred embodiment, the step S80 further comprises: judging whether to perform computation capability evaluation based on performance data of the consuming P2P device, if the performance data is less than a preset value, then the consuming peer device is not to perform computation capability evaluation. The performance data is size of RAM and/or CPU clock.

In step S81, the consmuning peer device sends the device message to a providing peer device of the same partner group. The device message includes a computation capability message, a message of number of requesting peer devices, and/or a data transmission bandwidth message.

In step S82, the providing peer device answers the consuming peer device with a response message. The response message includes a buffer map of multimedia data having one or more data segments.

In a preferred embodiment, the step S82 further comprises: deciding, by the providing peer device, whether to show specific data segments in the response message by means of candidate data selection; wherein the means of candidate data selection includes: (1) if all data segments have been converted, then the providing peer device shows all data segments in the response message; (2) if the providing peer device is unable to complete code conversion of the specific data segments before broadcasting ends, then the data segments unable to be completed are shown in the response message; and (3) if the consuming peer device has relatively strong computation capability, then the providing peer device shows extra data segments in the response message.

In another preferred embodiment, the buffer map includes a message of code conversion status, a message of code-convertible data, and/or a message of code-converted data.

In step S83, the consuming peer device performs work scheduling based on the response message.

In a preferred embodiment, the step S83 further includes: the consuming peer device divides an un-decoded data segment shown in the response message into an urgent data segment and a non-urgent data segment before broadcasting ends. At this moment, the consuming peer device is to download the urgent data segment first.

In another preferred embodiment, the consuming peer device calculates a downloading fraction for each data segment, and then decides whether to download the non-urgent data segment based on weight of the downloading fraction.

In step S84, the consuming peer device requests the providing peer device to deliver a specific data segment based on the outcome of work scheduling.

In step S85, the consuming peer device performs code conversion or broadcasting on the data segment received.

According to above descriptions of the preferred embodiments, the multimedia broadcast system and method supporting P2P coordinated code conversion according to the present invention are able to provide clients of multimedia data with instantly received video data; the present invention enables multimedia data clients to form a P2P system for performing coordinated code conversion tasks, thereby speeding up code conversion of multimedia data format, and providing advantages to devices of various display specification for receiving multimedia data.

The multimedia broadcast system and method supporting P2P coordinated code conversion according to the present invention have the following effects:
(1) Transmission performance of multimedia data provider can be improved. The present invention overcomes drawback of the prior art, wherein multimedia broadcast system takes up a great amount of transmission bandwidth. Since users are enabled to request data from other end-user devices, most of data transmission flow is scattered, thereby enhancing transmission bandwidth of multimedia data provider.
(2) Speeding up data code conversion. The present invention uses P2P system connection to allot data code conversion tasks to a plurality of P2P devices, data code conversion is completed by means of coordination, thereby greatly enhancing data code conversion speed, and enabling multimedia data to be broadcasted nearly lively on various receiving devices.

The foregoing descriptions of the detailed embodiments are only illustrated to disclose the features and functions of the present invention and are not interpreted as limiting the scope of the present invention. It should be understood to those in the art that all modifications and variation according to the spirit and principle of the disclosure of the present invention should fall within the scope of the appended claims.

What is claimed is:

1. A multimedia broadcast system for use in a network system, comprising:
a data source device for providing multimedia data; and
a plurality of P2P devices for receiving the multimedia data from the data source device via the network system and performing coordinated code conversion on the multimedia data, the P2P devices each being connected to one or more other said P2P devices to form a partner group via the network system.

2. The multimedia broadcast system of claim 1, wherein the P2P device comprises:
a computation capability evaluation module for evaluating computation capability of the P2P device and then generating a device message based on evaluation outcome, the device message including a computation capability message, a message of number of requesting peer devices, and/or a data transmission bandwidth message;
a message exchange module for delivering the device message to other said P2P devices of a same partner group, and receiving a response message sent back from other said P2P devices of the same partner group, wherein the message exchange module comprises a partner relation building module for forming the partner group from the P2P device and other said P2P devices connected therewith;
a work scheduling module for deciding whether to request a specific P2P device to download the multimedia data based on the response message received and/or broadcasting situation of the P2P device, thereby performing code conversion and/or broadcasting; and
a code conversion module for downloading the multimedia data and then performing code conversion thereon based on decision of the work scheduling module.

3. The multimedia broadcast system of claim 2, wherein the P2P device further comprises a candidate data selection module for deciding, upon receipt of the device message, whether to show the specific multimedia data in the response message..

4. The multimedia broadcast system of claim 1, wherein the network system includes Internet, intranet, LAN, and/or VPN, and the multimedia data are data in formats of MPEG-1, MPEG-2, MPEG-4, H.261, H.263, H.264, WMV, and/or YUV.

5. The multimedia broadcast system of claim 1, wherein the data source device and the P2P devices are servers, workstations, desktop computers, notebook computers, personal digital assistants, and/or mobile phones.

6. The multimedia broadcast system of claim 2, wherein the computation capability includes available CPU resource, CPU performance, and/or quantity of data that the P2P device to be processed in a swarming cycle and equivalent to the quotient obtained by dividing duration of the swarming cycle by average code conversion time of an individual datum.

7. The multimedia broadcast system of claim 2, wherein the response message includes a buffer map of multimedia data having one or more data segments, the buffer map including a message of code conversion status, a message of code-convertible data, and/or a message of code-converted data.

8. A multimedia broadcast method, configured for use in a multimedia broadcast system comprising a data source device and a plurality of P2P devices, comprising the steps of:
(1) forming, by the data source device, a data segment or a plurality of data segments from multimedia data;
(2) connecting the P2P device to another device or a plurality of other P2P devices to form a partner group via the network system, and acquiring the data segments from the data source device by the P2P device; and
(3) acquiring, by the P2P device of the partner group, schedule information and code conversion information from other P2P devices of the partner group and then executing coordinated code conversion and downloading on the multimedia data.

9. The multimedia broadcast method of claim 8, wherein the step (1) further comprises:
(1-1) sending separately by the P2P devices connected to the data source device, a computation capability message to the data source device;
(1-2) calculating, by the data source device, data distribution fraction based on the computation capability message received; and
(1-3) delivering, by the data source device, different data segments to the P2P devices connected thereto based on weight of the data distribution fractions.

10. The multimedia broadcast method of claim 8, wherein the P2P device requesting multimedia data for performing code conversion or broadcasting is defined as a consuming peer device, and the P2P device providing multimedia data is defined as a providing peer device, wherein the step (3) further comprises:
(3-1) evaluating, by the consuming peer device, computation capability of the consuming peer device, and generating a device message based on evaluation outcome;
(3-2) sending, by the consuming peer device, the device message to the providing peer device of a same partner group;
(3-3) answering, by the providing peer device, the consuming peer device with a response message;
(3-4) performing, by the consuming peer device, work scheduling based on the response message;
(3-5) requesting, by the consuming peer device, the providing peer device to deliver a specific data segment based on outcome of the work scheduling; and
(3-6) performing, by the consuming peer device, code conversion or downloading on the data segment received;
wherein the multimedia data are data in formats of MPEG-1, MPEG-2, MPEG-4, H.261, H.263, H.264, WMV, and/or YUV.

11. The multimedia broadcast method of claim 10, wherein the computation capability includes available CPU resource of the consuming peer device, CPU performance of the consuming peer device, and/or quantity of data that the consuming peer device is able to process.

12. The multimedia broadcast method of claim 11, wherein the quantity of data that the consuming peer device is able to process in a swarming cycle equals the quotient obtained by dividing duration of the swarming cycle by average code conversion time of an individual datum.

13. The multimedia broadcast method of claim 10, wherein the step (3-1) further comprises: judging, by the consuming peer device, whether to perform computation capability evaluation based on performance data thereof, wherein, upon judgment that the performance data is less than a preset value, the consuming peer device is not to perform computation capability evaluation.

14. The multimedia broadcast method of claim 13, wherein the performance data includes size of RAM of the consuming peer device and/or CPU clock of the consuming peer device.

15. The multimedia broadcast method of claim 10, wherein the device message includes a computation capability message, a message of number of requesting peer devices, and/or a data transmission bandwidth message.

16. The multimedia broadcast method of claim 10, wherein the response message includes a buffer map of multimedia data having a data segment or a plurality of data segments, the buffer map including a message of code conversion status, a message of code-convertible data, and/or a message of code-converted data.

17. The multimedia broadcast method of claim 11, wherein the step (3-3) further comprises deciding, by the providing peer device, whether to show specific data segments in the response message by means of candidate data selection.

18. The multimedia broadcast method of claim 17, wherein the means of candidate data selection comprises:
showing, by the providing peer device, all data segments in the response message if all data segments have been converted;
showing, by the providing peer device, a specific said data segment unable to be completely converted in the response message if the providing peer device is unable to complete code conversion of the specific said data segment before broadcasting ends; and
showing, by the providing peer device, extra data segments in the response message if the consuming peer device has relatively strong computation capability.

19. The multimedia broadcast method of claim 10, wherein the step (3-4) further comprises dividing, by the consuming peer device, an un-decoded data segment shown in the response message into an urgent data segment and a non-urgent data segment before broadcasting ends.

20. The multimedia broadcast method of claim 19, wherein the consuming peer device downloads the urgent data segment first, calculates a downloading fraction for each data segment, and then decides whether to download the non-urgent data segment based on weight of the downloading fraction.
